(19) United States
(12) Patent Application Publication
(10) Pub. No.: US 2018/0100639 A1
(43) Pub. Date: Apr. 12, 2018

(54) ARTICULATING L.E.D. LIGHTING SYSTEMS AND METHOD

(71) Applicant: Richard Bennett, Glenwood Springs, CO (US)

(72) Inventor: Richard Bennett, Glenwood Springs, CO (US)

(21) Appl. No.: 15/638,364

(22) Filed: Jun. 29, 2017

Related U.S. Application Data
(60) Provisional application No. 62/405,864, filed on Oct. 7, 2016.

(51) Int. Cl. F21V 19/00

(52) U.S. Cl. CPC F21V 19/0055; F21Y 2115/10; F21V 19/0025; F21V 19/002

(57) ABSTRACT

An L.E.D. lamp assembly providing a range of articulation between a lamp housing and a lamp is disclosed herein. The lighting system includes a lamp having an LED array, and a bell-shaped lamp housing having a threaded electrical connector attachable to a light socket, and an articulation mechanism. The articulation mechanism includes a pair of pivot arms attached to the lamp which ride within a channel attached to the lamp housing. By operation of the articulation mechanism, the L.E.D. lamp rotates on two axes; one parallel to the adapter's socket and one diametric to the circular edge of the adapter. The lighting system allows the L.E.D. lamp to be directed at various angles of a user's choice across a wall or ceiling when retrofitted into a light fixture.

### CROSS-REFERENCE TO RELATED APPLICATION

The present application is related to and claims priority to U.S. Provisional Patent Application No. 62/405,864 filed Oct. 7, 2016, which is incorporated by reference herein in its entirety.

### BACKGROUND OF THE DISCLOSURE

The following includes information that may be useful in understanding the present disclosure. It is not an admission that any of the information provided herein is prior art nor material to the presently described or claimed disclosures, nor that any publication or document that is specifically or implicitly referenced is prior art.

### 1. Field of the Disclosure

The present disclosure relates generally to the field of electric lighting and more specifically relates to adjustable light fixtures.

### 2. Description of Related Art

An electric light is a device that produces visible light using electric current. Electric lights are the primary form of artificial lighting in modern society, providing interior lighting for buildings and exterior lighting at night. In technical usage, a replaceable component that produces light from electricity is called a lamp. Compact lamps are commonly called light bulbs; for example, the incandescent light bulb. Lamps usually have a base made of ceramic, metal, glass or plastic, which secures the lamp in the socket of a light fixture. Conventional light bulb sockets receive, support, and electrically couple with light bulbs. A very common type of conventional light bulb is the A-type bulb commonly found in households, having a screw base. It is understood that there exist many standardized sizes and form factors for screw bases (e.g., Candelabra, Intermediate, Medium or standard, Mogul, etc.) and may be governed by standards such as ANSI standard C81.67 and IEC standard 60061-1.

One shortcoming of contemporary electric lights is that the angle of the light source is fixed by the orientation of the housing which the lamp is placed in. Most commercial light fixtures are non-adjustable, leaving users with no choice as to the direction of the light ray. As a result, electric lighting arrangements sometimes leave darker areas in corners, or produce too intense of a light due to their orientation. A suitable solution is desired.

Various attempts have been made to solve problems found in electric light art. Among these are found in: U.S. Patent and Publication Nos. 2009/0115304, 2014/0293603, 2010/0128473, and 7,810,945. This prior art is representative of electric lights.

None of the above disclosures and patents, taken either singly or in combination, is seen to describe the disclosure as claimed. Thus, a need exists for a reliable articulating L.E.D. system, and to avoid the above-mentioned problems.

### BRIEF SUMMARY OF THE DISCLOSURE

In view of the foregoing disadvantages inherent in the known adjustable light fixture art, the present disclosure provides a novel articulating L.E.D. lighting system. The general purpose of the present disclosure, which will be described subsequently in greater detail, is to provide an articulating L.E.D. lighting assembly with a pivotable and rotatable L.E.D. lamp.

A lighting device for an electrically powered conventional light bulb socket is disclosed herein. The lighting device includes a lamp adapter, a lamp, and an articulation mechanism, and attaches to an electrically powered conventional light bulb socket. The lamp adapter component includes both a light bulb socket interface for attaching to the convention light bulb socket and a bell housing which shields and supports the rest of the articulating lighting device. The lamp component includes a lamp housing for containing the lighting components, a plurality of light emitting diodes (L.E.D.s) attached to one face of the lamp housing, and a power circuit with a rectifier which electrically powers the lighting device. The articulation mechanism rotatably and pivotably couples the lamp to the lamp adapter.

According to another embodiment, a method of retrofitting an articulating L.E.D. lighting system to a stationary light fixture is also disclosed herein. The method includes screwing a light bulb socket interface into a conventional light bulb socket, rotating a lamp within a lamp adapter to a desired angle, sliding the lamp within the lamp adapter to a desired position, and illuminating an environment according to a selected radiation angle determined by the positioning of the lamp.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, an articulating L.E.D. lighting system, constructed and operative according to the teachings of the present disclosure.

FIG. 1 is a perspective view of an articulating L.E.D. system during an ‘in-use’ condition showing articulating L.E.D. attaching to a conventional light fixture socket, according to an embodiment of the present disclosure.

FIG. 2 is a perspective view illustrating the lamp adapter of the articulating L.E.D. system, according to an embodiment of the present disclosure.

FIG. 3 is an exploded view of the articulating L.E.D. system, illustrating its articulation mechanism, according to an embodiment of the present disclosure.

FIG. 4 is an exploded view of the articulating L.E.D. system, showing of the articulation axes according to an embodiment of the present disclosure. FIG. 4 is an exploded view of the articulating L.E.D. system, showing articulation axes, according to an embodiment of the present disclosure.

FIG. 5 is a flow diagram illustrating a method of retrofitting an articulating L.E.D. lighting system to a stationary light fixture, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to an adjustable light fixture and more particularly to an articulating L.E.D. lighting systems as used to improve the adjustability of the direction of the light in a range of directions.

Generally, the articulating L.E.D. lighting system may include an L.E.D. light bulb unit attachable to a light fixture. A housing uses a screw base to attach to the fixture, and contains a lamp having an articulation mechanism which may be positioned in a variety of directions within the fixture.

The present disclosure describes an adjustable lamp assembly which screws into a light fixture for interior or exterior use. The lamp uses an L.E.D. light source powered by conventional household current transmitted through the screw base connector. The screw base connector is attached to the back of a bell housing on the narrow end. The open end of the housing contains the L.E.D. light source, attached by means of an articulation mechanism having a circular channel inside the bell housing and a pair of pivot arms on the lamp. The articulation mechanism allows the light source to be adjusted at various angles. The design of the articulation mechanism allows the light source to be pivoted at an angle relative to the screw base connector, while also allowing 360 degrees of rotation concentric to the edge of the open end of the housing. This structure effectively allows the light to be angled relative to the screw base, and at any angle with a full 360 degrees of rotation relative to the axis of the screw base. The adjustments may be made by hand, and the lamp may retain the adjusted angle.

In use, the articulating L.E.D. system may be used to convert a stationary light fixture into a flexibly adjustable light source. For example, when retrofitted in a ceiling fixture facing downward, the lamp may be angled to shine light directly downward, towards a wall, or at an angle between the wall and floor. Multitudes of fixtures equipped with articulating L.E.D.s in combination may be used to make more customizable and effective lighting arrangements for both interior and exterior regions.

The articulating L.E.D. lighting system may include a lamp having an L.E.D. array, a lamp adapter, and an articulation mechanism. The lamp adapter may include a bell housing having an open end containing the lamp with the L.E.D. array such that is faces outwardly. The narrow end of the housing terminates in a screw-type electrical connector attachable to a household light bulb socket. Various embodiments may include an E12, E26, E39, or other type screw base connectors.

The interior of the lamp adapter includes the articulation mechanism channel which the pivot arms rides in. The channel encircles the interior region of the housing concentric to the edge of the open face of the bell housing. The channel may include a U-shaped trough with the open face oriented towards the interior region of the housing.

The articulation mechanism may include two diametrically opposed pivot arms which extend outwardly and perpendicular to the tangent of the channel. Each pivot arm rides inside the circular channel inside the light housing. The cross section of each pivot arm may be circular. This shape allows the articulation mechanism and L.E.D. array to rotate by riding along the inside of the channel and also to pivot along the axis of the two pivot arms. The continuity of the channel allows the array to rotate a full 360 degrees. Preferably, enough friction is present between the circular channel and the pivot arms to retain the set position of the articulation mechanism relative to the light housing.

Wires may transmit voltage between the screw base connector and the L.E.D. array. A live wire and a ground wire may provide a voltage differential to the array. The wires may be attached at one end the L.E.D. array, and at the other end to the interior section of the screw base connector.

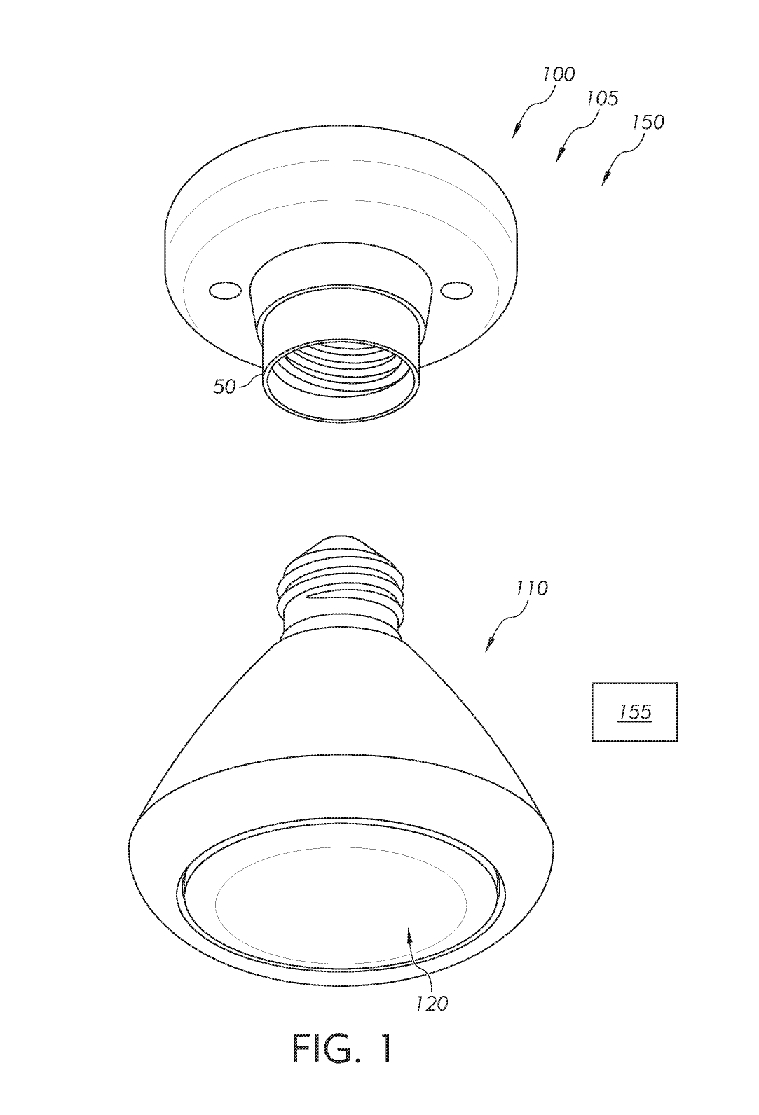

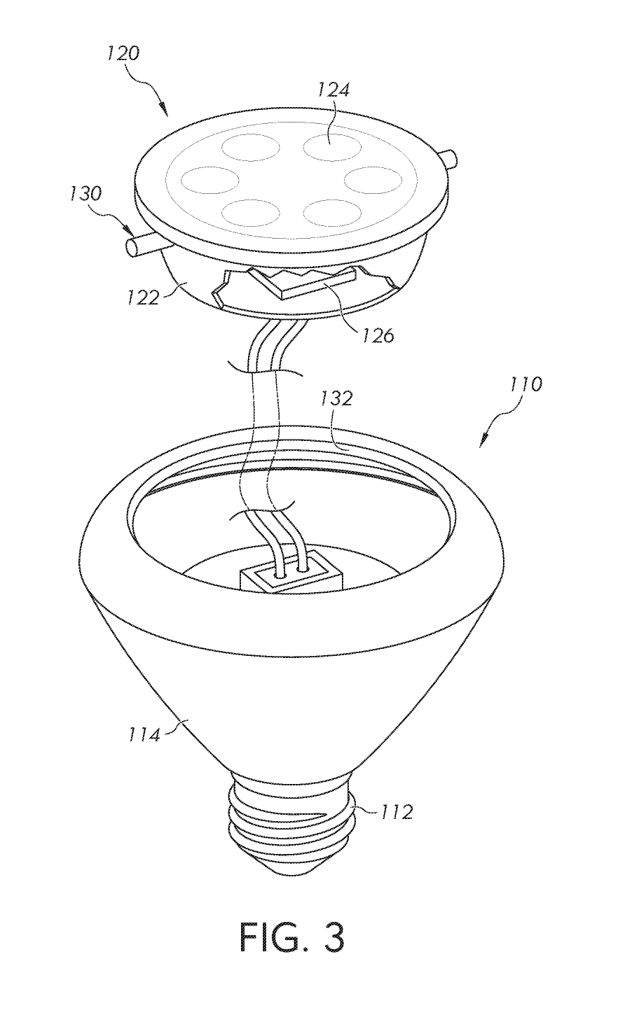

Referring now more specifically to the drawings by numerals of reference, there is shown in FIGS. 1-4, various views of a lighting system 100. FIG. 1 shows a lighting system 100 during an ‘in-use’ condition 150, according to an embodiment of the present disclosure. Here, the lighting system 100 may be beneficial for use by a user to retrofit an articulating L.E.D. lighting system to a light fixture. As illustrated, a lighting device 100 may include a lamp 120, a lamp adapter 110 configured to attach to electrically powered conventional light bulb socket 50, and an articulation mechanism 130 (FIG. 3). As shown, the articulation mechanism 130 may be configured to couple the lamp 120 to the lamp adapter 110 such that lamp 120 is nested within lamp adapter 110.

According to one embodiment, the articulating L.E.D. lighting system 100 may be arranged as a kit 105. In particular, the articulating L.E.D. lighting system 100 may further include a set of instructions 155. The instructions 155 may detail functional relationships in relation to the structure of the articulating L.E.D. lighting system 100 (such that the articulating L.E.D. lighting system 100 can be used, maintained, or the like, in a preferred manner).

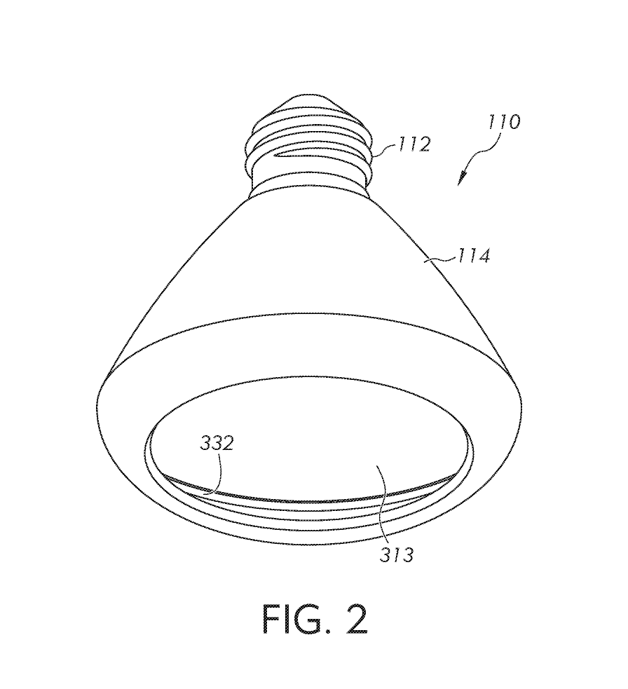

FIG. 2 is a perspective view illustrating the lamp adapter of the articulating L.E.D. system, according to an embodiment of the present disclosure. As above, the lighting device 100 may include the lamp adapter 110, the lamp 120, and the articulation mechanism 130.

As shown here, the lamp adapter 110 may further include a light bulb socket interface 112 and a bell housing 114. The light bulb socket interface 112 may be configured to interface with the conventional light bulb socket 50. As shown the bell housing 114 may be coupled to light bulb socket interface 112. Also as shown, the bell housing 114 may include an interior 313, and a channel 132 in its interior 313. Further, the channel 132 may circumscribe the interior 313 of bell housing 114 of lamp adapter 110.

FIG. 3 is an exploded view of the articulating L.E.D. system, illustrating its articulation mechanism, according to an embodiment of the present disclosure. As above, the lighting device 100 may include the lamp adapter 110, the lamp 120, and the articulation mechanism 130.

As shown, the lamp 120 may include a lamp housing 122, a plurality of light emitting diodes (L.E.D.s) 124 affixed to lamp housing 122, and a power circuit 126. The power circuit 126 may be configured to power the plurality of light emitting diodes 124 via power from the conventional light bulb socket 50 (FIG. 1). In particular, the power circuit 126 may be electrically coupled to the conventional light bulb socket 50 via the lamp adapter 110. According to one embodiment, the plurality of light emitting diodes 124 may be configured in an array such that they may produce concentrated radiation/illumination.

As shown, the articulation mechanism 130 may be configured to rotatably and pivotably couple the lamp 120 to the lamp adapter 110. In particular, the articulation mechanism 130 may be configured to ride within the channel 132 of the bell housing 114. For example, the articulation mechanism 130 may be configured to provide the lamp 120 with two degrees of freedom, as discussed below.

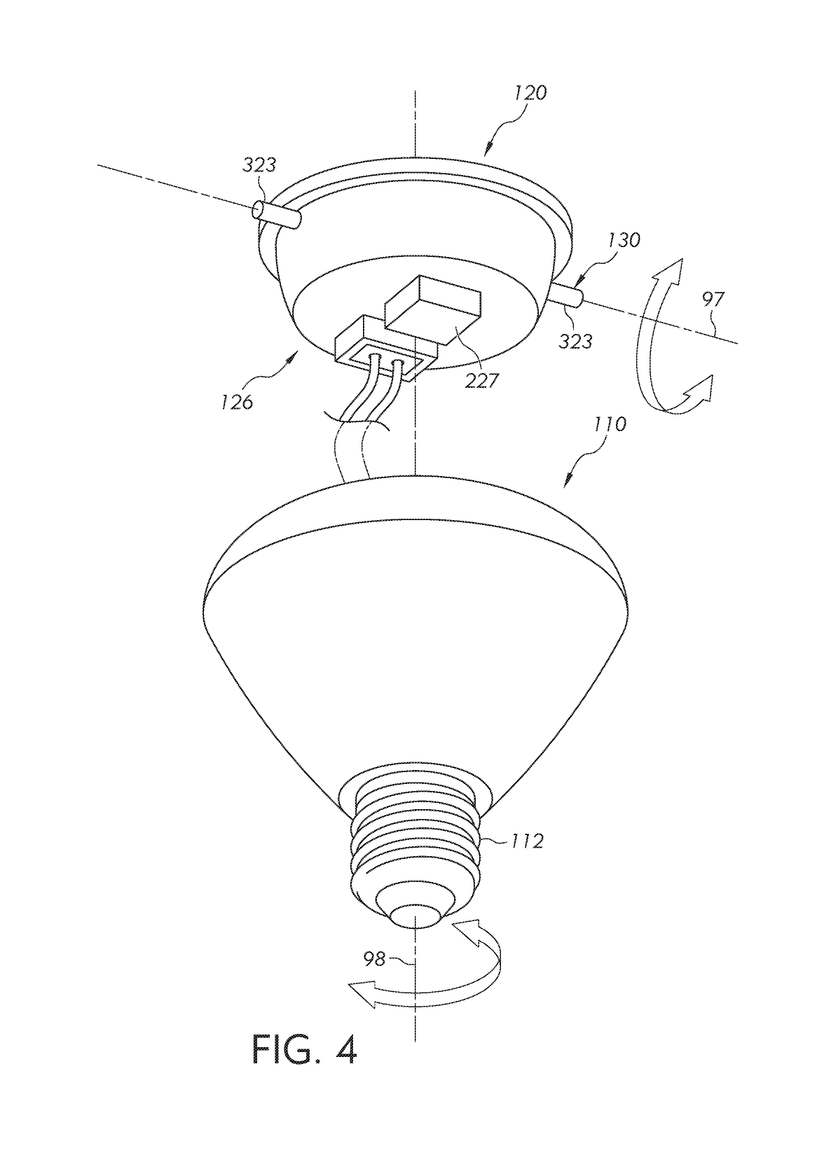

FIG. 4 is an exploded view of the articulating L.E.D. system, showing articulation axes, according to an embodiment of the present disclosure. As illustrated, the light bulb socket interface 112 may be embodied as screw cap 212, such as an Edison screw.

According to one embodiment, the power circuit 126 may include a rectifier 227. The rectifier 227 is configured to convert an alternating current received from light bulb socket interface 112 to a direct current, for transmission to plurality of light emitting diodes 124 (FIG. 3).

As discussed above, the articulation mechanism 130 may be configured to provide the lamp 120 with two degrees of freedom. In particular, the lamp 120 may rotate about rotation axis 98 and pivot about pivot axis 97.

As shown in FIG. 2, the channel 132 may circumscribe interior 313 of bell housing 114 of lamp adapter 110. As shown here in FIG. 4, the articulation mechanism 130 may include pair of pivot arms 323 extending from opposite sides of lamp 120 along the pivot axis 97. As assembled, the pair of pivot arms 323 radially extend into, and ride within, channel 132 of the lamp adapter 110. As such, the lamp 120 may rotate about rotation axis 98 while riding within the channel 132. Further, the lamp 120 may also pivot in channel 132 about the pivot axis 97.

According to one embodiment, the pair of pivot arms 323 may be configured as pivoting guide supports. In particular, the pair of pivot arms 323 may be disposed on opposite ends of lamp 120, extend radially from the lamp 120, relative to rotation axis 98, be cylindrically shaped, and configured for both sliding within channel 132 and pivoting about their own common axis (pivot axis 97). In operation, the lamp 120 rotates relative to lamp adapter 110 about rotation axis 98 as pair of pivot arms 323 slide within channel 132. Further, the lamp 120 has an adjustable radiation angle (direction of focus of light) which is may be selected by adjusting the lamp 120 and thus pivoting the pair of pivot arms 323 within channel 132. According to one embodiment the channel 132 may be made of or otherwise include a material of sufficient friction to resist free movement of pair of pivot arms 323. According to one embodiment, the lamp 120 may be limited to preset radiation angles, for example, by including detents or other irregularities in the articulation mechanism 130.

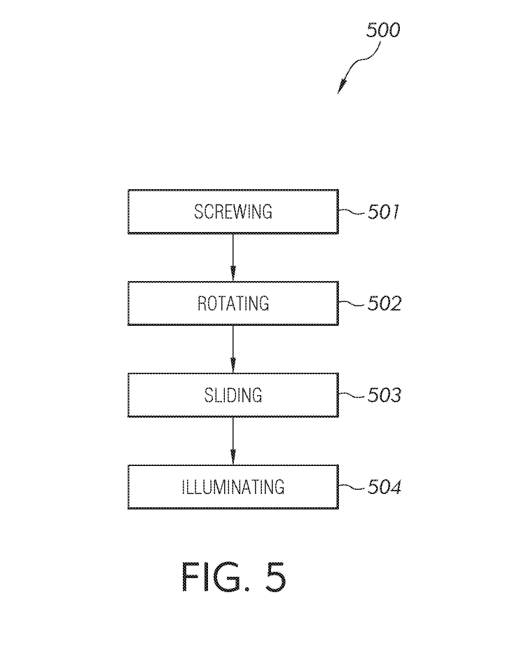

FIG. 5 is a flow diagram illustrating a method for retrofitting an articulating L.E.D. lighting system to a light fixture, according to an embodiment of the present disclosure. In particular, the method for retrofitting an articulating L.E.D. lighting system to a light fixture 500 may include one or more components or features of the lighting system 100 as described above. As illustrated, the method for retrofitting an articulating L.E.D. lighting system to a light fixture 500 may include the steps of: step one 501, screwing a light bulb socket interface into a conventional light bulb socket; step two 502, rotating a lamp within a lamp adapter to a desired angle; step three 503, sliding the lamp within the lamp adapter to a desired position; and step 504, illuminating an environment according to a selected radiation angle determined by the positioning of the lamp.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for retrofitting an articulating L.E.D. lighting system to a light fixture (e.g., different step orders within above-mentioned list, elimination or addition of certain steps, including or excluding certain maintenance steps, etc.), are taught herein.

Upon reading this specification, it should be appreciated that, under appropriate circumstances, considering such issues as user preferences, design preference, structural requirements, marketing preferences, cost, available materials, technological advances, etc., other arrangements such as, for example, alternative electrical fixture mechanisms, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lighting device for an electrically powered conventional light bulb socket, the lighting device comprising:
a lamp adapter including a light bulb socket interface and a bell housing, the light bulb socket interface configured to interface with the conventional light bulb socket, the bell housing coupled to the light bulb socket interface;
a lamp including a lamp housing, a plurality of light emitting diodes fixed to the lamp housing, and a power circuit, the power circuit configured to power the plurality of light emitting diodes via power from the conventional light bulb socket; and
an articulation mechanism configured to rotatably and pivotably couple the lamp to the lamp adapter.

2. The lighting device of claim 1, wherein the light bulb socket interface includes a screw cap;
wherein the power circuit includes a rectifier; and
wherein the articulation mechanism includes a channel circumscribing an interior of the bell housing of the lamp adapter about a rotation axis, and a pair of pivot arms extending from opposite sides of the lamp along a pivot axis, the pair of pivot arms configured to radially extend into the channel, to ride in the channel about the center axis, and to pivot in the channel about the pivot axis.

3. The lighting device of claim 2, wherein the screw cap is an Edison screw.

4. The lighting device of claim 2, wherein said pair of pivot arms are disposed on opposite ends of said lamp, said pair of pivot arms extending tangentially from said lamp.

5. The lighting device of claim 2, wherein said pair of pivot arms include cylindrical bodies.

6. The lighting device of claim 2, wherein said pair of pivot arms have fulcrums defining said pivot axis.

7. The lighting device of claim 2, wherein said lamp is configured to rotate relative to said lamp adapter as said pair of pivot arms slide within said channel.

8. The lighting device of claim 2, wherein said lamp has an adjustable radiation angle, said angle being selectable by the articulation of said pair of pivot arms within said channel.

9. The lighting device of claim 2, wherein said channel is further defined by a first bearing surface, a second bearing surface, and a third bearing surface.

10. The radial channel of claim 9, wherein said first bearing surface is perpendicular to said second bearing surface, and said second bearing surface is perpendicular to said third bearing surface, the combination thereof forming a square channel having an inwardly facing groove opening.

11. The lighting device of claim 9, wherein said second bearing surface is curved, said second bearing surface being conformed to and joined with said lamp adapter.

12. The lighting device of claim 9, wherein said first bearing surface, a second bearing surface, and a third bearing surface are each in contact with said pair of pivot arms.

13. The lighting device of claim 9, wherein said channel comprises a material of sufficient friction to resist free movement of said pair of pivot arms.

14. The lighting device of claim 2, wherein said rectifier is configured to convert an alternating current received from said light bulb socket interface to a direct current for transmission to said plurality of light emitting diodes.

15. The lighting device of claim 1, wherein said lamp is nested within said lamp adapter.

16. The lighting device of claim 1, wherein said plurality of light emitting diodes are configured in an array to produce a concentrated radiation.

17. The lighting device of claim 1, wherein said power circuit includes a live wire and a neutral wire configured as flexible electrical connection means between said light bulb socket interface and said power circuit.

18. An articulating L.E.D. lighting system comprising:
a lamp adapter including a light bulb socket interface and a bell housing, the light bulb socket interface configured to interface with the conventional light bulb socket, the bell housing coupled to the light bulb socket interface;
a lamp including a lamp housing, a plurality of light emitting diodes fixed to the lamp housing, and a power circuit, the power circuit configured to power the plurality of light emitting diodes via power from the conventional light bulb socket; and
an articulation mechanism configured to rotatably and pivotably couple the lamp to the lamp adapter; and
wherein the light bulb socket interface includes a screw cap;
wherein the power circuit includes a rectifier;
wherein the articulation mechanism includes a channel circumscribing an interior of the bell housing of the lamp adapter about a rotation axis, and a pair of pivot arms extending from opposite sides of the lamp along a pivot axis, the pair of pivot arms configured to radially extend into the channel, to ride in the channel about the center axis, and to pivot in the channel about the pivot axis;
wherein the screw cap is an Edison screw;
wherein said pair of pivot arms are disposed on opposite ends of said lamp, said pair of pivot arms extending tangentially from said lamp;
wherein said pair of pivot arms include cylindrical bodies;
wherein said pair of pivot arms have fulcrums defining said pivot axis;
wherein said lamp is configured to rotate relative to said lamp adapter as said pair of pivot arms slide within said channel;
wherein said lamp has an adjustable radiation angle, said angle being selectable by the articulation of said pair of pivot arms within said channel;
wherein said channel is further defined by a first bearing surface, a second bearing surface, and a third bearing surface;
wherein said first bearing surface is perpendicular to said second bearing surface, and said second bearing surface is perpendicular to said third bearing surface, the combination thereof forming a square channel having an inwardly facing groove opening;
wherein said second bearing surface is curved, said second bearing surface being conformed to and joined with said lamp adapter;
wherein said first bearing surface, a second bearing surface, and a third bearing surface are each in contact with said pair of pivot arms;
wherein said channel comprises a material of sufficient friction to resist free movement of said pair of pivot arms;
wherein said rectifier is configured to convert an alternating current received from said light bulb socket interface to a direct current for transmission to said plurality of light emitting diodes;
wherein said lamp is nested within said lamp adapter;
wherein said plurality of light emitting diodes are configured in an array to produce a concentrated radiation; and
wherein said power circuit includes a live wire and a neutral wire configured as flexible electrical connection means between said light bulb socket interface and said power circuit.

19. A method of retrofitting an articulating L.E.D. lighting system to a stationary light fixture, the method comprising the steps of:
screwing a light bulb socket interface into a conventional light bulb socket,
rotating a lamp within a lamp adapter to a desired angle,
sliding the lamp within the lamp adapter to a desired position, and
illuminating an environment according to a selected radiation angle determined by the positioning of the lamp.
